(19) United States
(12) Patent Application Publication
(10) Pub. No.: US 2005/0109689 A1
(43) Pub. Date: May 26, 2005

(54) Methods and apparatuses for filtering

(76) Inventor: Lawrence Marc Trachtenbroit, Basking Ridge, NJ (US)

Correspondence Address: NORA M. TOCUPS, P.O BOX 698, 140 PINECREST AVE, DECATUR, GA, 30030, US

(21) Appl. No.: 10/839,519

(22) Filed: May 5, 2004

Related U.S. Application Data
(60) Provisional application No. 60/523,838, filed on Nov. 20, 2003.

(51) Int. Cl. C02F 1/00

(52) U.S. Cl. 210/238

(57) ABSTRACT

Filter apparatuses and methods for use in a container containing a liquid with particles. A filter apparatus may include a filter sized to fit within the container, and a gasket around the filter creating a seal between the filter and inside of the container. A rod may be used to insert the filter and gasket into the container. The filter and gasket and the inside of the container below the inserted filter and gasket define a variable space to contain the filtered particles. Use of the filter apparatuses allows for removal of the liquid from the container, but leaves the particles. The filter may be a flat or concave disc, or a cup.

### CROSS-REFERENCE TO RELATED APPLICATION

The present application claims priority to and benefit of the prior filed co-pending and commonly owned provisional patent application, filed in the United States Patent and Trademark Office on Nov. 20, 2003, assigned Ser. No. 60/523,838, and incorporated herein by reference.

### FIELD OF THE INVENTIONS

The inventions relate generally to liquid filtration devices, and more particularly relate to devices that may be used to brew beverages and other liquid food products.

### BACKGROUND OF THE INVENTIONS

With the evolution of specialty coffee, tea and other beverages, consumers are expecting and demanding a greater selection of beverages that are of high quality, inexpensive, made to order, and are convenient when and where they want to enjoy them.

Restaurants and specialty coffee and tea shops typically brew their beverages in advance with traditional brewing systems that brew by delivering boiling or near boiling water over a bed of coffee grounds or tea leaves. The water flows through the grounds or leaves extracting the flavors, and then may flow through a paper or other filter into a thermal carafe or similar type container.

Generally, restaurants and specialty shops brew beverages in amounts that correspond to anticipated customers. Brewed beverages, however, cannot be stored indefinitely until the anticipated customers materialize. Coffee and other high quality beverages generally begin to deteriorate thirty minutes from being brewed. Some establishments continue to serve the brewed beverages even after the quality has begun to deteriorate. Many high-end restaurants, specialty shops, and convenience stores have adopted a procedure of brewing a new pot of coffee or tea every 20-30 minutes, discarding the previous pot. The waste resulting from this procedure is typically reflected in the price of the coffee or tea charged to customers at the high end restaurants and specialty shops. Other establishments take steps to minimize the waste and extra cost that may result from brewing more than needed for customers. These steps may include limiting the quantity and selection of types or flavors of brewed beverages that are available.

There is a need, therefore, for a way for restaurants, specialty shops, and other establishments to offer customers a wide selection of types and flavors of brewed beverages of high quality without the risks and costs associated with brewing too much or too many brewed beverages.

Some higher end restaurants avoid the problems discussed above by serving their customers coffee brewed by using the French press brewing system. Many consumers use this system as well. The French press brewing system is considered by many to be the “premier” method of brewing a high quality beverage. The French press brewing system is considered to result in coffee having a great flavor and consistency due, in part at least, to control of the extraction time and delivery of all of the oils that are often trapped in the paper filters of traditional brewing devices.

There is a French press in the French press brewing system. A French press typically includes a container of rigid material such as glass, metal, or plastic. Coffee of “coarse” grind is measured into the container and near-boiling water is poured over the grounds. After a period to allow for brewing, a plunger unit is inserted into the container and pushed through contents of the container so the brewed liquid is filtered and separated from the coffee grounds. The coffee grounds are trapped at the bottom of the container. The coffee may be poured from a spout in the container into a cup, mug, or other individual serving unit.

Even though the coffee, or tea or other brewed beverages, brewed according to the French press brewing system is considered by many to be excellent, the system presents several drawbacks. A first drawback is that a consumer who desires a cup of French press brewed coffee must own or have access to a French press brewing system. In other words, the consumer (or other person at the consumer's place of access) must invest in the French press brewing system by purchasing the French press equipment including container and plunger. Another drawback is that a French press brewing system typically is sized to deliver several cups of coffee. Even if a consumer desires only a single cup of coffee, he or she may have to use a French press brewing system sized for more than one cup. The consumer may be able to brew only a cup of coffee in that system, but measurements may be difficult to make and procedures may be difficult to follow to obtain an excellent single serving of French press coffee. Another drawback is that the French press brewing system requires the time and effort of the consumer in cleaning of at least the container and plunger between uses. The grounds and any remaining oils have to be washed out of the container as well as the plunger in the French press brewing system.

The previously mentioned disadvantages of the French press brewing system including necessity of investment in the equipment, the size of the equipment relative to a single serving, and the necessity of cleaning the equipment contribute to a final disadvantage of the French press brewing system mentioned here. That disadvantage is the relative lack of mobility of the French press brewing system. Given the cost of the system, its size, and need for cleaning, the French press brewing system is not readily transportable by a consumer. Thus, the convenience of the French press brewing system is limited.

Another device that may be used to brew coffee, tea or other beverages is referred to herein as a “press pot”. The press pot has gained popularity in the kitchen as a useful straining tool in the preparation of soups, sauces as well as other creative culinary visions. Like the French press brewing system, a press pot has a container into which a plunger is inserted. The plunger may or may not include a filter or straining device.

A press pot, however, has uses other than brewing, and thus, may lack certain features that are convenient or even necessary for brewed beverages, and may include other features that pose a problem for the brewing of beverages. For example, a press pot may not include a spout in its container. To remove the contents from a press pot's container, the contents may be simply poured out over the sides of the press pot or out through a small opening in the press pot's cover. As another example, the plunger of the press pot may not necessarily keep the coffee grounds, tea leaves, or other flavoring residue separate from the brewed liquid. A consumer pouring a cup of coffee from the press pot may pour coffee grounds into his or her cup or mug as well as the brewed beverage.

Further, a press pot generally includes a cap or cover for its container. Once the plunger is pressed into the contents of the container, the cap usually “locks” to cover the top of the container. It may be difficult to recover the brewed beverage from the press pot through a hole or other opening in the press pot's cover, especially if the handle of the plunger protrudes through the same opening in the cover of the press pot.

The press pot has at least a disadvantage in common with the French press brewing system. Like the French press brewing system, a press pot requires the time and effort of the consumer in cleaning the press pot's equipment between uses.

As noted, the popularity of the use of press pots has grown among consumers. Thus, a drawback of the press pot for brewing beverages is that it may be in demand for other uses. A consumer may need to have two or three press pots on hand to have a press pot available for brewing beverages as well as for other uses such as in cooking.

If a press pot is used for brewing coffee, it is usually designed to brew four or more cups of coffee at a time. There have been some attempts to create a press pot to brew an individual cup of coffee. However, such press pots remain difficult to clean. There have been some attempts in the market to create a disposable press pot for individual use. However, the patented designs that have been disclosed are considered to be costly to manufacture and of impractical designs.

Another type of device used to brew beverages is referred to herein as the “whole cup-size strainer” or simply “strainer”. Coffee grounds, tea leaves, or other flavorings are placed into a container. Hot water (or other liquid) is poured into the container and allowed to brew. To allow the consumer to drink the brewed beverage without the coffee grounds, tea leaves, or other flavoring residue, a strainer shaped like the container, but smaller, is inserted into the container. The strainer nestles into the container, filters the brewed liquid, and separates it from the coffee grounds, tea leaves, or other flavoring residue. The consumer may drink the beverage from the container with the strainer in place, or, with the strainer in place, may pour the beverage into a cup, mug, or other serving piece.

Like the other brewing devices mentioned, the whole cup-size strainer has drawbacks. To strain the flavoring residue effectively, the whole cup-size strainer must be specially made to substantially match the inside of the container with which it is to be used. One disclosed design is a whole cup-size strainer that fits into an individual serving size cup. This design is considered to be costly to manufacture. Another drawback of the whole cup-size strainer is that it may be easily misused. If the whole cup-size strainer is forced too quickly or forcefully into the liquid with the brewing materials, the whole-cup size strainer may force a portion, even a large portion, of the contents out of the container, which may cause burns from the hot liquid as well as creating a mess.

In sum, there is a need for a way for consumers to conveniently and easily make or obtain a single-serving of a high quality brewed beverage from among a wide selection of flavors and types of such beverages. There is a need for a way for consumers to make or obtain the high quality brewed beverage without investment in expensive equipment or multiple sets of equipment, without having to make large quantities of the brewed beverage, and without having to clean the equipment.

### SUMMARY

Generally, the inventions relate to methods and apparatuses that allow for the brewing of a beverage with flavoring particles and that allow for the consumption of the beverage without the flavoring particles.

Advantageously, the inventions provide a way for restaurants, specialty shops, convenience stores, and other establishments to offer customers a wide selection of types and flavors of brewed beverages of high quality without the risks and costs associated with brewing too much or too many brewed beverages. The inventions also provide a way for consumers to conveniently and easily make or obtain a single-serving of a high quality brewed beverage from among a wide selection of flavors and types of such beverages. In addition, the inventions provide a way for consumers to make or obtain the high quality brewed beverage without investment in expensive equipment or multiple sets of equipment, without having to make large quantities of the brewed beverage, and without having to clean the equipment.

There are many possible embodiments of the inventions. An exemplary embodiment of the inventions includes a filter apparatus for use in a container containing a liquid with particles. The filter apparatus includes a filter disc sized to fit within the container. The filter apparatus also includes a gasket around the perimeter of the filter disc to create a seal between the filter disc and the inside side surface of the container. In addition, the filter apparatus includes a rod with one end of the rod attached generally perpendicularly to the top and substantially center of the filter disc. The rod may be used to insert and move the filter disc with the gasket in the container so the filter disc and the gasket may filter the particles from the liquid and keep substantially all the filtered particles separated from the liquid. Thus, the filter apparatus may be used with a liquid having particles such as coffee including coffee grounds or tea including tea leaves. The filter apparatus passes the brewed coffee or the tea, but blocks passage of the coffee grounds or tea leaves.

In the exemplary filter apparatus, substantially all the filtered particles may be contained in a defined space between the inserted filter disc with the gasket and the inside surface of the container below the inserted filter disc with the gasket. The filter disc of the filter apparatus may be substantially flat, concave, or another shape. The filter disc with the gasket may be of a shape and size substantially conforming to the inside of a horizontal cross section of the container. The filter disc with the gasket may be configured as a cup such that, when inserted into the container, the cup opens towards the top of the container. The bottom of the cup may be sized and shaped to conform substantially to the inside bottom of the container. The rod that may be used to insert the filter disc into the container may be separable from the filter disc.

Another exemplary embodiment of the inventions may include a filter sized to fit in a vessel such as a single-serving sized container. The filter passes fluid, but blocks substances of a certain size and smaller. To accomplish this function, the filter may include a frame with filtering material. The filter is positionable for moving through the fluid in the container while filtering a substance from the fluid. The filter traps the substance in the vessel so the fluid is removable from the container without the substance. For example, the filter may have a diameter sufficient to fit relatively tightly against the inside side surface of the vessel at a set distance from the bottom of the vessel. The space defined between the bottom of the filter and the inside of the vessel below the filter may be used for containing the filtered substance. The defined space may be variable to account for different types and/or amounts of filtered substance. The filter may be shaped to substantially correspond to the inside of a horizontal cross-section of the vessel. Further, the filter may be flat, concave, or assume another shape such as a cup.

The filter of the exemplary embodiment may have a cylindrical attachment. One end of the cylindrical attachment may be attached to the perimeter of the filter and may extend towards the opening of the vessel when the filter with the cylindrical attachment is inserted into the vessel. The cylindrical attachment may include a plurality of openings that allow the fluid to pass.

The filter of the exemplary embodiment also may include a plunger with one end of the plunger being attached to the top of the filter, and the plunger may be used to move the filter through the fluid. The plunger may be removed from the filter after its use.

In addition, the filter of the exemplary embodiment may include a gasket around the perimeter of the filter for creating a seal between the filter and the inside side surface of the vessel. The filter may include a collar disposed around and perpendicular to the filter for positioning the filter with respect to the inside side surface of the vessel.

The inventions further include methods such as an exemplary method for separating substantially all the flavor residue from a brewed beverage in the cup so as to allow for removal of the brewed beverage without substantially all the flavor residue. In this method, a filtrative/separation device is inserted into the cup. The filtrative/separation device includes a filter conforming generally in size and shape to the inside of a horizontal cross section of the cup so the filter forms a seal with the inside side surface of the cup. The filter may include a sealing ring to further the forming of the seal. The filtrative/separation device is moved through the brewed beverage with the flavor residue to allow the filter of the filtrative/separation device to pass the brewed beverage, but block passage of substantially all the flavor residue from the brewed beverage. The filtrative/separation device traps substantially all the flavor residue from the brewed beverage in a space between the filtrative/separation device and the bottom of the cup. Thus, the brewed beverage without substantially all the flavor residue may be removed from the cup.

Referring to the exemplary method described above, the filtrative/separation device may be configured as a cup. The cup of the filtrative/separation device is inserted into the cup holding the brewed beverage with the flavor residue. The cup of the filtrative/separation device filters substantially all the flavor residue from the brewed beverage. The cup of the filtrative/separation device may include vents, holes, or other openings disposed on or near its top, or otherwise. The vent, holes, or other openings provide a way for any portion of the brewed beverage that gets passed the sealing ring of the filtration/separation device to return to the cup holding the brewed beverage. The cup holding the brewed beverage with the flavor residue may be referred herein as the “first” cup, and the cup of the filtrative/separation device may be referred to herein as the “second” cup.

Advantageously, the inventions allow restaurants, cafes, convenience stores, and other vendors to offer filtered beverages. For example, a consumer may purchase a single-size serving of hot tea, and be provided with a cup containing tea leaves. Hot water may be poured into the cup, and time allowed for brewing the tea. As part of the purchase, the consumer may be provided with a filter or filter apparatus. Once the tea has brewed, the consumer may insert the filter or filter apparatus into the liquid so the filter or filter apparatus filters and separates the tea leaves from the liquid now referred to as tea. The consumer then may enjoy the tea without hindrance by the tea leaves.

Other features and advantages of the inventions may be more clearly understood and appreciated from a review of the following detailed description and by reference to the appended drawings and claims.

### BRIEF DESCRIPTION OF THE DRAWINGS

FIG. 1 illustrates an exemplary filter apparatus in a container.

FIGS. 2A-2D illustrate exemplary configurations of a gasket as may be used with a filter in an exemplary filter apparatus.

FIGS. 3A-3G illustrate exemplary filters as may be used with an exemplary embodiment.

FIG. 4 illustrates an exemplary embodiment of a filter apparatus.

### DETAILED DESCRIPTION

In a brewed beverage, such as coffee or tea, the coffee grounds or tea leaves are usually separated from the brewed liquid before consumption. The inventions relate to methods and apparatuses for separating the coffee grounds or tea leaves from the brewed liquid. In addition to coffee or tea, the inventions may be used with other beverages, other liquids, fluids, and may even be used with other substances. A liquid may also be referred to herein as a beverage, brewed beverage, fluid, and by like terms. A substance such as the coffee grounds or tea leaves that may be present in the liquid to give it flavor may be referred to herein as particles, flavor particles, brewing residue, or flavor or flavoring residue, or like terms.

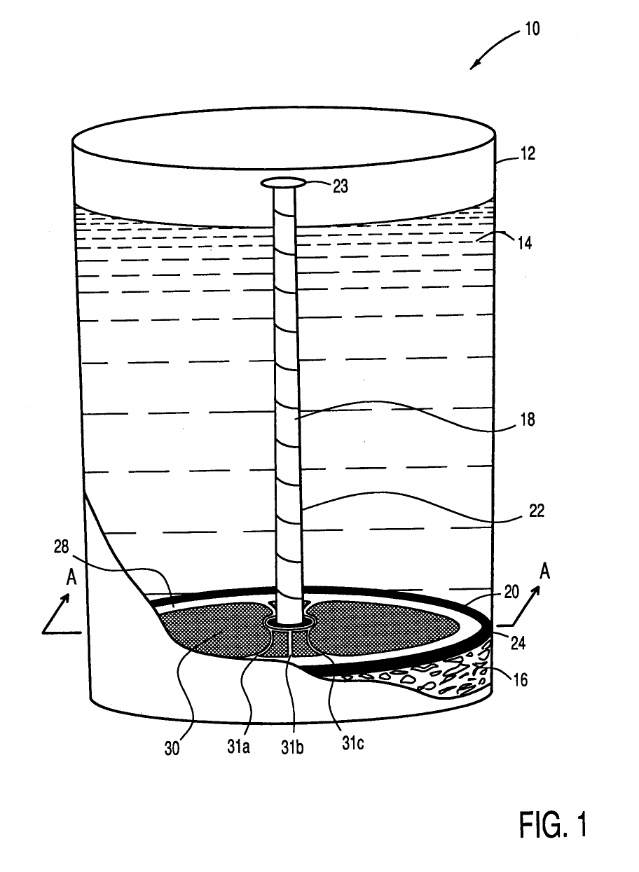

FIG. 1 illustrates an environment 10 including a container 12 filled with a liquid 14 that has been filtered of particles 16 (such as coffee grounds, tea leaves, or other flavoring residue) by an exemplary embodiment 18 of the inventions that keeps the particles 16 separate from the liquid 14. The exemplary embodiment 18 may be referred to as a filtration device, filtrative device, filter device or apparatus, filter/separation device, or filtration/separation device.

Advantageously, the filter apparatus 18 may be used with a container 12 that allows for a single-serving, but the filter apparatus 18 also may be sized for containers of more than one serving. A container may be or may be referred to as a cup, a “first” cup, a glass, a mug, a pot, a carafe, a vessel, or the like. Moreover, the container 12 may be disposable such as after a one-time use, or may be re-usable. The container 12 may be constructed of almost any appropriate material including paper, plastic, etc. The illustrated container 12 is generally cylindrical, but does not necessarily have to be. For example, to allow for stacking of similar containers, the container may have a generally cylindrical form, but be slightly tapered from larger in diameter at the top to smaller at the bottom, or the container may be cone-shaped.

Another advantage of the filter apparatus 18 is that it may be used as a filter/separation device (with appropriate configuration) with most types or kinds of liquids. The liquids most often referenced herein are beverages such as coffee and tea, but the filter apparatus 18 may be used with other liquids, and may even be used with other substances in certain circumstances.

Further, even though the exemplary embodiment 18 is referred to as a “filter”, “filter/separator” apparatus, or something similar, the exemplary embodiment 18 may be used in situations that do not include nor require any “filter” and/or “separation” functions. For example, the exemplary embodiment 18 and other embodiments may be used as a sort of “strainer” with a liquid or other substance of varying consistency to achieve a more even consistency throughout the liquid or other substance. Moreover, the exemplary embodiment and other embodiments may be used with a container when no “filter” or “separation” functions are carried out.

Generally, the examples provided herein refer to the liquid 14 as a single type of liquid like coffee or tea. Nevertheless, the liquid 14 may be of more than one type or may be a mix. Also, the examples herein refer to the particles 16 as a single type of particle such as coffee grounds or tea leaves. As with the liquid 14, the particles 16 may be of more than one type or may be a mix of types. In addition, the examples herein refer to particles 16 that “flavor” a liquid such as coffee grounds, tea leaves, etc. The inventions are not limited to use with such particles, but may be used with particles that do not “flavor” a liquid.

FIG. 1 illustrates the filter apparatus 18 as including a filter 20 that may be separably attached to one end of a rod 22. The rod 22 may be used to insert and move the filter 20 into the container 12. The rod 22 may include a handle 23 at its end opposite the filter 20 to aid in the use of the filter apparatus 18. As the filter 20 is moved into the container 12 from the top towards the bottom of the container 12, the filter 20 separates the particles 16 from the liquid 14 as the filter 20 is moved through the liquid 14. The separably attached rod 22 may be removed from filter 20 after the filter 20 is inserted into the container (or otherwise). The rod 22 may be used as a tool to stir the liquid. Additional information about the rod 22 and the handle 23 is provided below following the immediate discussion relating to the filter 20.

In the exemplary embodiment, the filter 20 is a filter disc substantially flat on both sides and relatively thin in vertical cross section. The flatness and the thinness of the filter disc may aid to minimize the amount of space taken up by the filter disc in the container. By taking up less space, the filter apparatus allows for more liquid, beverage or other content in the container. The thinness of the filter disc may depend on the content and/or manner of its construction. For example, the filter disc may be no thicker than necessary to allow for a filtering and a separation function.

Even though exemplary filters illustrated and discussed herein are generally shaped as “discs”, the filter of the filter apparatus should not be so limited. For example, an alternate filter may have a convex and/or concave (rather than flat) shape. Another alternative filter may have a cup-like shape that conforms generally to the or part of the inner surface of the container. Further, a filter also maybe referred to as a strainer, separator, sieve, purifier, sifter, winnower, screener, or like term.

To filter substantially all of the particles 16 from the liquid 14 and to keep at least most of the filtered particles 16 separate from the liquid 14, the filter 20 is sized and shaped generally in horizontal cross section to fit within the container 12. The filter 20 is sized and shaped generally to create a seal with the inside of the container at some point on the inside side surface of the container 12. An alternate embodiment of the inventions, discussed below, may include a gasket, sealing ring, collar, a cylindrical attachment or other element(s) around the filter 20 to create, effect, support, or maintain the seal with the inside of the container 12.

Advantageously, the match or seal between the filter 20 and the inside side surface of the container 12 is maintained even as the filter apparatus 18 is moved further into and towards the bottom of the container 12. As the filter 20 moves through the liquid filtering particles, the filtered particles 16 are trapped underneath the filter 20 of the filter apparatus 18. Advantageously, by use of the filter apparatus 18, a consumer may drink a brewed beverage without interference from the residue of the brewing process.

To create the seal between the filter 20 and the inside of the container, the filter 20 may be of a size and shape that substantially corresponds to the inside of a horizontal cross section of the container. For example, if the container 12 is generally cylindrical, then the filter may be circular and may have a size that fits just within the container 12. As another example, if the container 12 is generally cylindrical, but larger at the top than at the bottom, the filter 20 may be circular and may be of a size sufficient to separate substantially all of the particles 16 as the filter 20 is moved from the top to the bottom of the container; but yet, the filter 20 may fit as far into the container as nearly to the inside bottom of the container.

How far the filter fits into the container may depend, at least in part, on the size, amount, and/or other characteristics of the filtered particles as well as other elements in the environment. Thus, the space below the inserted filter apparatus may be a variable space. The ability to vary the space between the bottom inside of the container and the filter is an advantage. Such variance allows for the filter apparatus to be used in different circumstances as possibly determined by the filter size, by the container, and/or by the consumer, so as to accommodate different amounts, types, grinds or other differences of brewing materials. For example, a consumer may prefer a strong cup of coffee and the space under the filter may need to be greater than for a weak cup of coffee to accommodate an adequate amount of coffee grounds used to brew the strong cup of coffee.

The filter apparatus 18 may be inserted into the container 12 and moved towards the bottom of the container 12 until the filter apparatus 18 does not move any further towards the bottom. This position of the filter apparatus 18 is referred to as the “fully inserted” position. In this position, substantially all of the particles have been filtered from the liquid and are trapped underneath the filter 20 of the filter apparatus 18. Advantageously, the filter apparatus 18 may compress or be made to compress the filtered particles 16 towards the bottom of the container 12 to obtain as much filtered liquid 14 as possible.

Another advantage of the inventions is that the exemplary filter apparatus 18 may be used to obtain filtered liquid 14 without full insertion of the filter apparatus 18 into the container 12. This advantage is derived at least in part from the configuration of the filter 20 with respect to the inside side surface of the container 12. As noted above, the filter 20 generally is sized to fit just within the inside side surface of the container 12. Once the filter apparatus 18 is inserted into the container 12, the filter 20 generally matches the inside side surface of the container 12. This match creates a seal that generally does not allow particles 16 to pass between the filter 20 and the inside side surface of the container 12. Even if the filter apparatus 18 is only partially inserted into the liquid 14, generally no particle or few particles avoid the filter function of the filter 20. Thus, liquid 14 that is filtered by the filter apparatus 18, even if it is only partially inserted, is generally free from particles 16. As a result, a consumer may be able to consume or obtain at least some filtered liquid 16 even if the filter apparatus 18 is inserted only at least partially into the liquid 14. This partial insertion may be useful to a consumer to test whether enough brewing has occurred to the consumer's satisfaction without having to completely insert the filter apparatus 18.

In an alternative embodiment, the filter apparatus and the container may be configured with respect to each other in a way that provides for a “resting place” of the filter apparatus within the container. With the filter apparatus in the resting place, it may be more difficult to remove the filter apparatus from the container than if the filter apparatus is otherwise positioned in the container. The added difficulty, even if only slight, in removal of the filter apparatus aids in the consumption or removal of the liquid from the container without interference by the filter apparatus and/or whatever it has trapped.

For example, the filter of the filter apparatus may be sized to form a relative seal or match with the inside side surface of the container once the filter apparatus is inserted into the container, even if the insertion is only partial. Yet, at a specified place within the container such as at a set distance from the bottom of the container, (such as the “fully inserted position”), a relationship may be created between the filter of the filter apparatus and the inside side surface of the container that results in a specific fit between the filter and the inside side surface. When the filter is specifically fitted with the inside side surface of the container, the filter apparatus is said to be in its resting place.

The resting place of the filter apparatus with the specific fit between the filter and the inside side surface of the container may be achieved in a number of different ways. For example, the filter may more tightly fit the inside side surface at the resting place than at any other place with respect to the inside side surface of the container. The tight fit may be the result of a greater seal or match between the filter and the inside side surface of the container at the resting place than elsewhere.

As another example, the specific fit may be the result of tongue and groove connection or the like or other connection between the filter and the inside side surface of the container. For example, a container may include a groove at a particular point on its inside side surface. The filter may be sized to fit into the groove to form the specific fit. A groove also may be referred to as a notch, path, track, or like term.

As additional example, the specific fit may be achieved by the interaction between the filter and a stop or ridge disposed on the inside side surface of the container. For example, a ridge protruding towards the center of the container from the inside surface of the container may be disposed near the bottom inside of the container. The ridge generally is of a size to stop or make more difficult further movement of the filter towards the bottom inside of the container. Effectively, the filter “sits on top” of the ridge and the specific fit is created between the filter and the inside side surface of the container.

The filter apparatus 18 may be constructed to include additional elements to help create or to supplement the match or seal between the filter 20 and the inside side surface of the container 12. As illustrated in FIG. 1, the exemplary embodiment of the filter apparatus 18 includes such an optional additional element. This additional element may be referred to as a gasket, a sealing ring, sealer, ring, or like term.

The exemplary filter apparatus 18 includes a gasket 24 disposed around the periphery of the filter 20. In embodiments of the filter apparatus 18 where a seal or match is not created or not created relatively tightly between the filter 20 and the inside side surface of the container 12, the gasket 24 may be used to create or to improve the match or seal. The gasket may be made of flexible rubber, rubber-like material, plastic, or other such bendable or flexible food-grade material that may create or improve a match or seal between the filter 20 and the inside side surface of the container 12. The gasket's composition also may ease insertion/withdrawal of the filter 20 with respect to the container 12 without compromising the filter's filtering function. For example, the gasket's composition may be more flexible than the composition of the filter 20. Further, the gasket 24 may be configured with the filter 20 and with respect to the inside of the container to create an embodiment of the specific fit described above.

The gasket 24 may take any number of forms as appropriate for its function with the filter and with respect to the inside of the container. Four examples of gasket 24 or its use are described below.

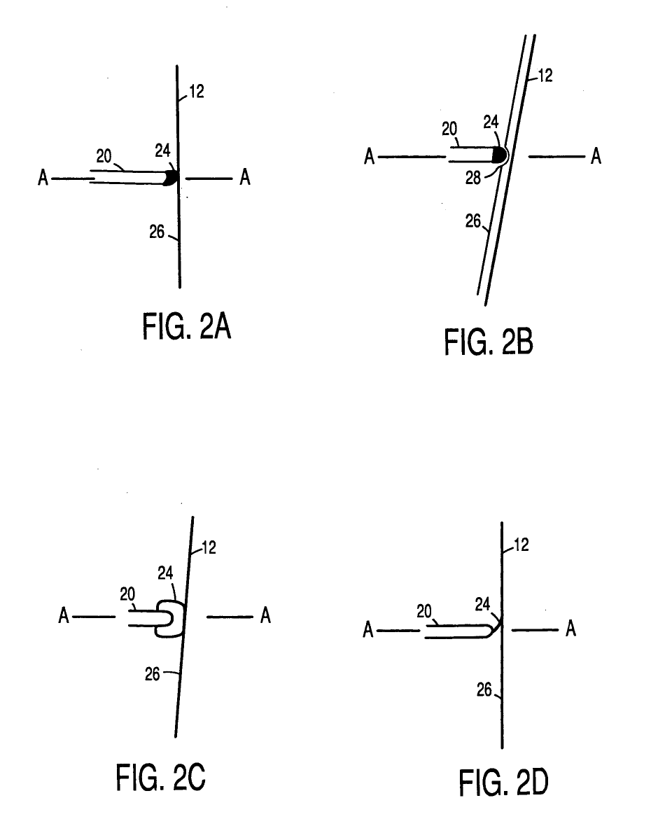

FIG. 2A illustrates the first gasket example with a partial cross section taken along “A” of part of the filter apparatus 18 inserted into container 12. The filter apparatus 18 includes the filter 20 with a gasket 24 disposed around its periphery. The gasket 24 may be simply an extension of the filter 20 so that the gasket 24 creates a seal with the inside side surface 26 of the container 12.

FIG. 2B illustrates the second gasket example with a partial cross section taken along “A” of part of the filter apparatus 18 inserted into container 12. The filter apparatus 18 includes the filter 20 with a gasket 24 disposed around its periphery. The gasket 24 may be an extension of the filter 20, and the gasket 24 may be shaped or configured to form an embodiment of the specific fit discussed above between the filter 20 and the inside side surface of the container 12. In the embodiment of FIG. 2B, the inside side surface 26 of the container 12 includes a groove 28. The gasket 24 may be configured to fit the groove 28 to form the specific fit between the filter and the inside side surface 26 of the container 12.

FIG. 2C illustrates the third gasket example with a partial cross section taken along “A” of part of the filter apparatus 18 inserted into container 12. The filter apparatus 18 includes the filter 20 with a gasket 24 disposed around its periphery. Further, the gasket 24 is disposed in vertical cross section in a substantially “C” shape with the filter 20 fitting into the center of the “C”. As illustrated, when the filter apparatus 18 is inserted into the container 12, the gasket 24 creates a seal or match between the filter 20 and the inside side surface 26 of the container 12.

Advantageously, the “C” shape of gasket 24 in FIG. 2A may be specifically configured to ease insertion of the filter apparatus 18 into the container 12. In addition, or alternatively, the “C” shape of gasket 24 may be specifically configured to make withdrawal of the filter apparatus 18 from its container 12 relatively difficult (or at least more difficult than insertion).

FIG. 2D illustrates the fourth gasket example with a partial cross section taken along “A” of part of the filter apparatus 18 inserted into container 12. The filter apparatus 18 includes the filter 20 with a gasket 24 disposed around its periphery. Further, the vertical cross section of this exemplary gasket 24 is a substantially flat shape, and may be thinner than the vertical cross section of the filter 20. The substantially flat shape of the gasket 24 and/or its composition may allow the gasket 24 to function similarly to a wiper blade. As illustrated, when the filter apparatus 18 is inserted into the container 12, the gasket 24 creates a seal or match between the filter 20 and the inside side surface 26 of the container 12.

As noted above, a function of the filter in the filter apparatus is to allow for passage of the liquid (or other substance) and to block passage of the particles. The filter may be constructed in many ways to accomplish this function. The filter 20 of the exemplary embodiment shown in FIG. 1 includes a frame 28 holding or supporting a filtering material 30. The exemplary frame 28 is generally wheel shaped with interior supporting arms such as arms 31a-c. The arms may add rigidity to the filter as well as hold or support the filtering material. In addition, the frame 28 may function to aid the filter 20 in withstanding the upward press of the liquid as the filter is moved through the liquid into the container 12. The frame 28 may be made of plastic or other food-grade material, such as paper, recycled paper, wood, cardboard, laminated paper, or the like.

As illustrated in FIG. 1, the filtering material 30 is supported by the frame 28 and supported by its arms such as arms 31a-c. The filtering material 30 may be made of a different substance than the frame 28. Alternatively, the filtering material may be integral with the frame. Further, the filtering material may vary in composition and other characteristics depending on the liquid, and/or the particles in the liquid. The filtering material may be a nylon mesh, perforated solid material, or other food-grade filtering mechanism.

For example, the filtering material may be chosen to filter a specific type of particle such as tea leaves, coffee grounds, etc. The filtering material 30 of the exemplary embodiment illustrated in FIG. 1 has a mesh configuration. The filtering material 30 may be of a finer mesh (smaller openings), or coarser mesh (larger openings) as appropriate to the liquid and particles to be filtered and/or separated.

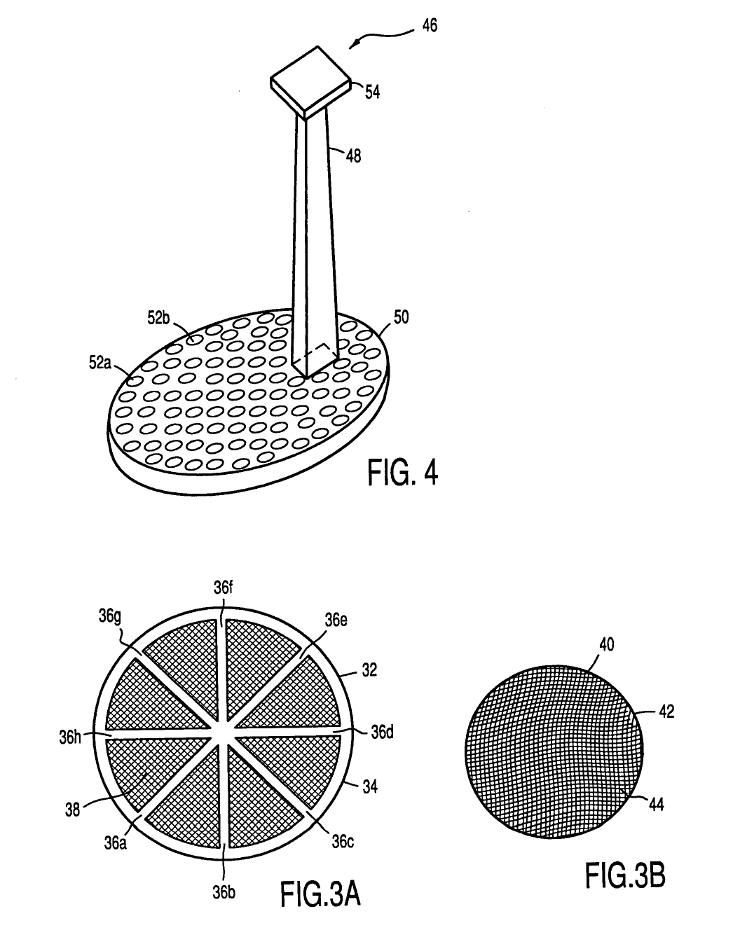

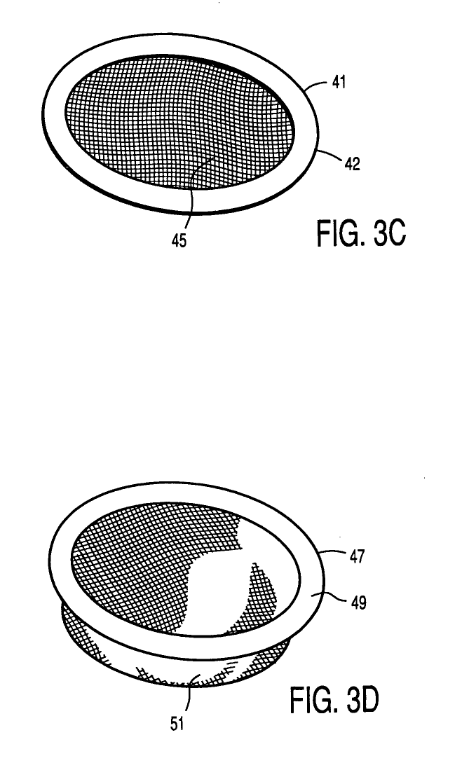

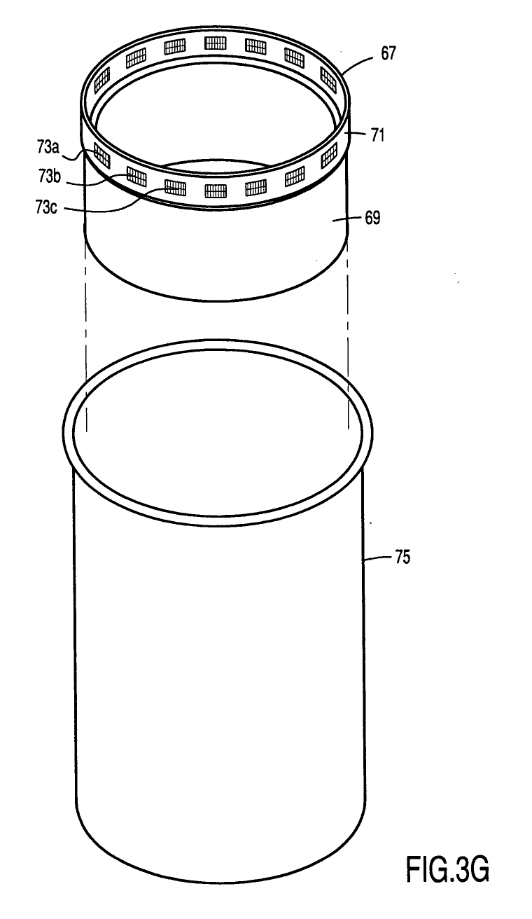

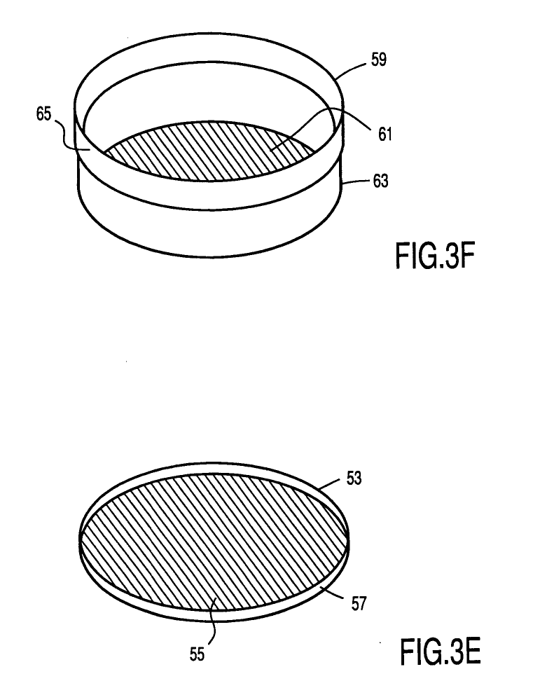

FIG. 3A illustrates a top view of another exemplary filter 32 that may be used as a filter or in a filter apparatus. The filter 32 includes a frame 34 that is generally wheel shaped and includes eight (8) symmetrical spokes 36a-h. A filtering material 38 in a mesh configuration is disposed between the spokes 36a-h and within the frame 23. Alternative configurations of the exemplary filter 32 will be apparent to those skilled in the art such as a configuration with a differently shaped frame, with more or less spokes, with different filter material, etc.

FIG. 3B illustrates a top view of yet another exemplary filter 40 as may be used with a container or with a filter apparatus. The filter 40 includes a peripheral frame 42 in the shape of a circle. The filter 40 also includes filtering material 44 that may be similar to the material of a conventional tea bag, and may appear almost cloth-like to the consumer. In an alternative embodiment, the filter 40 could be a perforated strainer device. As yet another alternative, the filter 40 may not include a peripheral frame, but be simply made up of a filtering material 44. Alternative configurations of the exemplary filter 40 will be apparent to those skilled in the art such as a configuration with a differently shaped frame, with different filter material, etc.

FIG. 3C illustrates a top view of yet another exemplary filter 41 that may be used in a filter apparatus or otherwise. The filter 41 includes a frame 43 that is generally circular, and may function as a gasket or a sealing ring. A filtering material 45 is set within the frame 43. Alternative configurations of the exemplary filter 41 will be apparent to those skilled in the art such as a configuration with a differently shaped frame, with different filter material, etc.

FIG. 3D illustrates a perspective view of another exemplary filter 47 that may be used in a filter apparatus or otherwise. The filter 47 includes a frame 49 that is generally circular, and may function as a gasket or a sealing ring. A filtering material 51 is set within the frame 49. In this exemplary filter 47, the filter material 51 is disposed in a concave configuration with the opening of the filter 47 towards the top of the container as the filter 47 is inserted into the container. Alternative configurations of the exemplary filter 47 will be apparent to those skilled in the art.

FIG. 3E illustrates a perspective view of yet another exemplary filter 53 that may be used in a filter apparatus or otherwise. The filter 53 includes a filtering material 55 that may or may not be set within a frame. In this exemplary filter 53, the filtering material 55 is of a generally circular disposition. Around the periphery or perimeter of the filtering material 55 (or frame if included) is a collar 57 that is set generally perpendicular to the filtering material 55. The collar is disposed around the “top” of the filtering material 55 as the filtering material 55 is positioned to be inserted into a container, vessel, or cup. The “height” or “length” of the collar 57 may vary as chosen for any particular use. For example, the height of the collar 57 may match the height of the container in which the filter 53 is disposed. As another example, the height of the collar 57 may be only slight when compared to the height of the container. Alternative configurations of the exemplary filter 53 will be apparent to those skilled in the art.

FIG. 3F illustrates a perspective view of even yet another exemplary filter 59 that may be used in a filter apparatus or otherwise. The filter 59 includes a filtering material 61 that may or may not be set within a frame. In this exemplary filter 59, the filtering material 61 is of a generally circular disposition. Around the periphery or perimeter of the filtering material 61 (or frame if included) is a collar 63 that is set generally perpendicular to the filtering material 61. The collar is disposed around the “top” of the filtering material 61 as the filtering material 61 is positioned to be inserted into a container, vessel, or cup. The “height” or “length” of the collar 63 may vary as chosen for any particular use. In addition, the collar 63 may include a lip 65 disposed around the top of the collar 63. The lip 65, rather than the whole collar 63, (or in addition and as part thereof) may form part of the seal between the filter 59 and the inside surface of the container into which it is inserted.

Effectively, the collar 63 including the lip 65 and the filter material 61 may be configured as a “cup” with a “small wall” or cup “side surfaces” for insertion into the container.

FIG. 3G illustrates a perspective view of even yet another exemplary filter 67 that may be used in a filter apparatus or otherwise. The filter 67 includes a filtering material (only illustrated in part in FIG. 3G) that may or may not be set within a frame. In this exemplary embodiment 67, the filtering material is of a generally circular and flat disposition so as to make up substantially most of the bottom of a cup as configured by the exemplary filter 67. Around the periphery or perimeter of the bottom (such as the bottom of the cup of the filtering material, or frame if included) is a collar 69 that is set generally perpendicular to the filtering material. The collar 69 also may be referred to as a cylindrical attachment. In other words, one end of the cylindrical attachment 69 is attached to the filtering material that serves as the bottom of a “cup”. The collar 69 is disposed around the “top” of the filtering material as the filtering material is inserted into a container, vessel, or cup. The “height” or “length” of the collar 69 may vary as chosen for any particular use. In addition, the collar 69 may include a lip 71 disposed around the top of the collar 69. The lip 71, rather than the whole collar 69, may form part of the seal between the filter 69 and the inside surface of the container into which it is inserted.

Moreover, the lip 71 of the collar 69 may include vents 73a-c etc. (holes, openings, or otherwise) to allow fluid to pass. The vents 73a-c etc. may include filtering material or otherwise. A use of the vents 73a-c may be to return any part of the brewed beverage that gets passed the seal between the filter and the cup to the cup.

Effectively, the collar 69 including the lip 71 (if present) and the filter material may be configured as a “cup” with a “small wall” or cup “side surfaces” for insertion into a container 75 such as illustrated in FIG. 3G. Alternative configurations of the exemplary filter 53 will be apparent to those skilled in the art.

FIG. 4 illustrates another exemplary filter apparatus 46 including a rod 48 and filter 50. The filter 50 provides an additional example of a possible configuration for filtering. The filter 50 is a circular shaped disc of a material such as plastic, cardboard, or other material. The disc is perforated by openings or holes as illustrated by the exemplary holes 52a-b. Advantageously, the filter 50 may be integrally formed without the need for a frame or other supporting device or other the filtering material. Alternatively, the holes 52a-b may be filled with a filtering material.

Examples of a filter as may be used in a filter apparatus have been described herein. The inventions should not be limited to these examples, but may include other configurations for performing the filtering and/or separation functions with respect to a brewed beverage.

As described above, the filter apparatus of the inventions may include a rod connected to the filter, and the rod may be used to insert the filter into the container and to move the filter towards the bottom of the container. The rod may be separable from the filter. The rod also may be used to remove the filter apparatus from the container. In addition, the rod may be used to stir or otherwise mix the brewed beverage. A rod may also be referred to herein as a plunger, a plunger rod, a filter stick, a stick, or like term.

As illustrated in FIGS. 1 and 4, one end of the rod may be attached to the filter. The other end of the rod may be used to insert or otherwise move the filter with respect to the container. The rod, however, may be otherwise attached or separably attached to the filter. For example, the rod may be connected to the filter so that a part of the rod extends below the filter and the remainder of the rod extends above the filter.

Typically, the amount of the rod extending below the filter is less than the amount of the rod extending above the filter, and in an embodiment, may be a small percentage of the overall length of the rod. The part of the rod extending below the filter may serve as a spacer to create a space between the bottom inside of the container and the bottom or underside of the filter. In an exemplary embodiment, the amount of rod extending below the filter may be varied so as to vary the space between the bottom inside of the container and the bottom of the filter. The ability to vary the space is advantageous so as to accommodate different types and/or characteristics of the filtered particles or otherwise.

Further, a rod with part extending below the filter may be used as an aid by the consumer in positioning the filter apparatus inside the container. For example, the consumer may insert the filter apparatus into the container until the consumer feels the part of the rod extending below the filter touch the bottom inside of the container. Optionally, the bottom inside of the container may include a positioning device such as a depression to receive or connect to the tip of the part of the rod extending below the filter. As an example, the bottom inside of the container may include an indentation to receive the referenced tip of the rod.

The filter apparatus 18 shown in FIG. 1 includes a rod 22 connected to the filter 20 at its center. The rod, however, may otherwise be attached or separably attached to the filter. FIG. 4 illustrates a rod 48 that is connected to the filter 50 at a place to one side of the filter 50 closer to the periphery than to the center. Generally, the rod may be connected to the filter in a filter apparatus at a place on the filter that allows the rod to be used by the consumer in using the filter apparatus.

The connection of a rod to a filter may be made in any number of ways. For example, the end of the rod to be separably attached to the filter may include a connection device in a specified shape, such as a cross shape, to fit into a corresponding connection element on the filter.

FIG. 1 illustrates the rod 22 to be in a generally perpendicular position with respect to the filter 20. Nonetheless, a rod may be otherwise positioned such as on an angle.

A rod may be made of the same material as the filter, or part(s) of the filter such as the frame. Alternatively, the rod may be made of a different material. A rod may be integrally formed with the filter, or even with a part(s) of the filter such as the frame. In an embodiment, the connection between the rod and the filter is separable so that, for example, the filter and/or the rod may be used separately. In another embodiment, the connection between the rod and the filter may be such that separation is possible, but not in the ordinary course of use of the filter apparatus.

The rod 22 of FIG. 1 is generally cylindrically shaped, but does not necessarily have to be. The rod 48 of FIG. 4 has a generally square horizontal cross section. Moreover, the rod may have a taper such as rod 48, which has a taper of decreasing size of the horizontal cross section from the end of the rod 48 connected to the filter 50 to the other end of the rod 48 connected to the handle 54.

A rod of a filter apparatus may be hollow, partially hollow, or solid as appropriate to the composition of the rod and to its use as part of the filter apparatus. A rod may be relatively rigid to allow for its use in facilitating the insertion and movement of the filter with respect to the container. The relative rigidity may be such as to prevent breaking or bending of the rod, or to otherwise affect the use of the filter apparatus.

The length of a rod also may be varied depending on a number of factors such as the size of the filter apparatus, and/or of the container in which the filter apparatus may be used, and the type or other characteristics of the liquid and/or the particles. The length of a rod may be set so as to allow for use of the filter apparatus in conventional disposable cups such as may be used with coffee or other beverages.

As illustrated in FIG. 1, the rod 22 has a length such that it rises above the level of a full serving for the container 12 when the filter apparatus is fully inserted and is separating the flavoring residue from the liquid. A rod, however, may be longer or shorter with respect to the container in which the filter apparatus may be used.

The rod 22 of the filter apparatus 18 of FIG. 1 is shown connected to a handle 23 at the end of the rod 22 opposite to the end connected to the filter 20. The handle 23 may facilitate use of the filter apparatus 18 by the consumer. For example, the consumer may hold the filter apparatus 18 by its handle 23. The handle 23 may have other uses as well such as a display function for providing information or advertising. As an example, a trademark for the filter apparatus 18 may be displayed on the top of the handle 23.

In the exemplary embodiment illustrated in FIG. 1, the handle 23 is generally disc shaped, substantially flat, sized slightly larger than the diameter of the rod 22. The handle 23, however, may be almost any shape for ease of grip and each of pushing, such as a knob or ball. The handle 23 is disposed generally perpendicularly to the rod 22. Also in this example, the handle 23 is connected at its center to the rod 22. The handle 23 may be integrally formed with the rod 22. Alternatively, the handle 23 may be separably connected to the rod 22. As yet another alternative, the handle 23 may be separably connected to the rod 22, but such separation is not contemplated in ordinary use of the filter apparatus. The handle 23 may be made of the same or a different material as the rod 22. The handle 23 is generally solid, but does not necessarily have to be.

FIG. 4 illustrates an alternative handle 54 as used with filter apparatus 46. Handle 54 is generally of a square shape and sized larger than a horizontal cross section of the rod 48.

Even though the illustrated examples of filter apparatuses in this description include a handle, a filter apparatus according to the inventions does not have to have a handle. Moreover, a handle may be of a different shape and positioned differently with respect to its rod than the illustrated embodiment.

Other features and advantages of the inventions may be more clearly understood and appreciated from a review of the following detailed description and by reference to the appended drawings and claims.

1. A filter apparatus for use in a container containing a liquid and particles in the liquid, the filter apparatus comprising:
a filter disc sized to fit within the container;
a gasket around the perimeter of the filter disc for creating a seal between the filter disc and the inside side surface of the container; and
a rod with one end of the rod attached generally perpendicularly to the top and substantially center of the filter disc,
whereby the rod may be used to insert and move the filter disc with the gasket in the container so the filter disc and the gasket may filter the particles from the liquid and keep substantially all of the filtered particles separated from the liquid.

2. The apparatus of claim 1, wherein the inserted filter disc with the gasket and the inside surface of the container below the inserted filter disc with the gasket define a variable space to contain substantially all of the filtered particles.

3. The apparatus of claim 1, wherein the filter disc comprises a substantially flat filter disc.

4. The apparatus of claim 1, wherein the filter disc with the gasket comprises a shape and size substantially conforming to the inside of a horizontal cross section of the container.

5. The apparatus of claim 1, wherein the filter disc with the gasket comprises a cup that, when inserted into the container, opens toward the top of the container.

6. The apparatus of claim 5, wherein the cup comprises a bottom with a shape and size substantially conforming to the inside bottom of the container.

7. An apparatus, comprising:
a filter sized to fit in a vessel;
the filter operative to pass fluid in the container and to block substances of a certain size and smaller;
the filter being positionable for moving through the fluid in the container while filtering a substance from the fluid in the container; and
the filter being operative to trap the substance in the vessel so the fluid is removable from the container without the substance.

8. The apparatus of claim 7, wherein the vessel comprises a single-serving sized container.

9. The apparatus of claim 7, wherein the filter is sized to fit just within the inside side surface of the vessel.

10. The apparatus of claim 7, wherein the filter comprises filtering material set within a frame.

11. The apparatus of claim 7, wherein the filter has a diameter sufficient to fit relatively tightly against the inside side surface of the vessel at a set distance from the bottom of the vessel.

12. The apparatus of claim 7, wherein the filter comprises a shape substantially corresponding to the inside of a horizontal cross-section of the vessel.

13. The apparatus of claim 7, wherein the filter comprises a concave shape as the filter is inserted into the vessel.

14. The apparatus of claim 7, further comprising a cylindrical attachment attached at one end to the perimeter of the filter and extending towards the opening of the vessel when the filter with the cylindrical attachment are inserted into the vessel.

15. The apparatus of claim 14, further comprising a plurality of openings in the cylindrical attachment.

16. The apparatus of claim 7, further comprising a plunger with one end of the plunger being attached to the top of the filter,
whereby the plunger may be used to move the filter through the fluid.

17. The apparatus of claim 7, wherein the one end of the plunger is attached to the top and substantially center of the filter.

18. The apparatus of claim 7, wherein the plunger is attached generally perpendicularly to the top of the filter.

19. The apparatus of claim 7, wherein the plunger is separably attached to the filter.

20. The apparatus of claim 7, wherein the % bottom of the filter and the inside of the vessel below the filter define a space for containing the filtered substance.

21. The apparatus of claim 20, wherein the space comprises a variable space dependent upon positioning of the filter in the vessel.

22. The apparatus of claim 7, wherein the plunger comprises a handle attached to the end of the plunger opposite to the end of the plunger attached to the filter.

23. The apparatus of claim 7, further comprising a gasket around the perimeter of the filter for creating a seal between the filter and the inside side surface of the vessel.

24. The apparatus of claim 7, further comprising a collar disposed around the filter and perpendicular to the filter for positioning the filter with respect to the inside side surface of the vessel.

25. With respect to a cup containing a brewed beverage with flavor residue, a method for separating substantially all the flavor residue from the brewed beverage in the cup to allow for removal of the brewed beverage without substantially all the flavor residue, the method comprising:
inserting a filtrative/separation device into the cup, the filtrative/separation device including a filter conforming generally in size and shape to the inside of a horizontal cross section of the cup so the filter forms a seal with the inside side surface of the cup;
moving the filtrative/separation device through the brewed beverage with the flavor residue to allow the filter of the filtrative/separation device to pass the brewed beverage, but block passage of substantially all the flavor residue from the brewed beverage; and
causing the filtrative/separation device to trap substantially all the flavor residue from the brewed beverage in a space between the filtrative/separation device and the bottom of the cup,
whereby the brewed beverage without substantially all the flavor residue may be removed from the cup.

26. The method of claim 25, wherein the filter comprises a sealing ring disposed around the periphery of the filter.

27. The method of claim 25, wherein the cup comprises a first cup;
wherein the filtrative/separation device comprises a second cup with the second cup being smaller than the first cup, and with the second cup opening towards the top of the first cup when the second cup is inserted into the first cup; and
wherein the second cup comprises vents disposed near the top of the second cup for passing the brewed beverage from the first cup into the second cup.
